(19) United States
(12) Patent Application Publication
(10) Pub. No.: US 2026/0274119 A1
(43) Pub. Date: Sep. 17, 2026

(54) SEATBACK LOCK DEVICE AND VEHICLE SEAT

(71) Applicants: NHK SPRING CO., LTD., Yokohama-shi (JP); SUBARU CORPORATION, Tokyo (JP)

(72) Inventors: Jun AOKI, Yokohama-shi (JP); Tomoya TAKAHASHI, Yokohama-shi (JP); Yosuke ISHIYAMA, Tokyo (JP); Taiki ONO, Tokyo (JP)

(21) Appl. No.: 19/567,647

(22) Filed: Mar. 16, 2026

(30) Foreign Application Priority Data
Mar. 17, 2025 (JP) 2025-042958

(51) Int. Cl. B60N 2/20; B60N 2/64

(52) U.S. Cl. CPC B60N 2/20; B60N 2/646

(57) ABSTRACT

A seatback lock device including a lock main body that is coupled to a side portion of a frame of a seatback coupled so as to be tiltable in a forward direction with respect to a floor section of a vehicle body, and that engages with a striker provided at a side portion of the vehicle body, a lever that is arranged at a seat width direction inner side with respect to the lock main body so as to be coupled to the lock main body, and that releases engagement between the lock main body and the striker by being displaced toward a seat upper side, and a downward urging member that is spanned between the lever bracket and the frame, and that urges the lever bracket toward a seat lower side.

### CROSS-REFERENCE TO RELATED APPLICATION

This application is based on and claims priority under 35 USC 119 from Japanese Patent Application No. 2025-042958 filed on Mar. 17, 2025, the disclosure of which is incorporated by reference herein.

### BACKGROUND

### Technical Field

The present disclosure relates to a vehicle seat, and in particular relates to a seatback lock device.

### Related Art

In a vehicle seat disclosed in Japanese Patent Application Laid-Open (JP-A) No. 2024-51098, a lock main body of a lock device provided at a side portion of a seatback engages with a striker coupled to a side portion of a vehicle body. An operation member for releasing locking by being pulled upward is coupled to the lock main body, and a strap for pulling the operation member upward is coupled to the operation member.

### SUMMARY

A vehicle seat such as this is, in addition to the strap for releasing locking of the lock main body, sometimes also equipped with a remote cable for releasing locking of the lock main body by remote operation. In such a vehicle seat, for example, both the strap and the remote cable are coupled to a lever that has been coupled to the lock main body. Unwanted release of the locking of the lock main body could occur were such a lever to be lifted up unintentionally due to inertial force during a vehicle collision.

An object of the present disclosure is to obtain a seatback lock device and a vehicle seat that are able to prevent unwanted release of the locking of a lock main body provided at a seatback side portion due to inertial force during a vehicle collision.

A seatback lock device of a first aspect of the present disclosure includes a lock main body that is coupled to a side portion of a frame of a seatback coupled so as to be tiltable in a forward direction with respect to a floor section of a vehicle body, and that engages with a striker provided at a side portion of the vehicle body, a lever that is arranged at a seat width direction inner side with respect to the lock main body so as to be coupled to the lock main body, and that releases engagement between the lock main body and the striker by being displaced toward a seat upper side, and a downward urging member that is spanned between the lever and the frame, and that urges the lever toward a seat lower side.

In the seatback lock device of the first aspect, the lock main body coupled to the frame side portion of the seatback coupled so as to be tiltable in a forward direction with respect to the vehicle body floor section engages with the striker provided at the side portion of the vehicle body. The lever arranged at the seat width direction inner side with respect to the lock main body is coupled to the lock main body, and releases the engagement between the lock main body and the striker by being displaced toward the seat upper side. The downward urging member is spanned between this lever and the frame of the seatback. The lever is accordingly urged toward the seat lower side by the downward urging member. This thereby enables unwanted release of the locking of the lock main body to be prevented due to being able to prevent the lever from being lifted up unintentionally by inertial force during a vehicle collision or the like.

A seatback lock device of a second aspect is the first aspect, further including a forward urging member that spans between the lever and the frame, and that urges the lever toward a seat front side.

In the seatback lock device of the second aspect, the lever is urged toward the seat front side by the forward urging member spanned between the lever and the frame of the seatback. This thereby enables, for example, the generation of abnormal noise from the lever interfering with other components due to vibration or the like during vehicle travel to be prevented.

The seatback lock device of a third aspect is the second aspect, wherein part of the lever is pressed against part of the frame by urging force of the forward urging member.

In the seatback lock device of the third aspect, part of the lever is pressed against part of the frame by urging force of the forward urging member and so the generation of abnormal noise due to the interference referred to above can be even better prevented.

A seatback lock device of a fourth aspect is the third aspect, wherein the forward urging member is arranged further toward the seat upper side than the downward urging member.

In the seatback lock device of the fourth aspect, the forward urging member is arranged as described and so a configuration can be achieved in which, for example, urging of the lever toward the seat lower side by the downward urging member is not impeded by the forward urging member.

A seatback lock device of a fifth aspect is any one aspect of the first aspect to the fourth aspect, wherein the frame includes a lever protector covering the lever from a seat front side, and the downward urging member spans between a lower end portion of the lever protector and the lever.

In the seatback lock device of the fifth aspect, the lever is covered from the seat front side by the lever protector provided at the frame. The downward urging member is spanned between a lower end portion of the lever protector and the lever, and so urging of the lever toward the seat lower side by the downward urging member can be achieved efficiently.

A seatback lock device of a sixth aspect is the fifth aspect depending from any one aspect of the second aspect to the fourth aspect, wherein the forward urging member spans between an upper end portion of the lever protector and the lever.

In the seatback lock device of the sixth aspect, due to the forward urging member being spanned between the lever and the upper end portion of the lever protector covering the lever from the seat front side, the lever can be urged toward the seat front side efficiently by the forward urging member.

A vehicle seat of a seventh aspect includes a seat cushion for an occupant of a vehicle to sit on, a seatback that is coupled so as to be swingable with respect to a vehicle body and that supports a back of the occupant, and the seatback lock device of any one aspect of the first aspect to the sixth aspect, wherein the lock main body is provided at a side portion of the seatback.

In the vehicle seat of the seventh aspect, the back of the occupant seated on the seat cushion is supported by the seatback. The seatback is coupled so as to be swingable with respect to the vehicle body. A lock main body of a seatback lock device is provided at the seatback side portion. The lock device is that of the one aspect of the first aspect to the sixth aspect and so the above described advantageous effects are obtained.

As described above, the seatback lock device and vehicle seat according to the present disclosure enables the prevention of unwanted release of the locking of the lock main body provided at the seatback side portion due to inertial force during a vehicle collision.

### BRIEF DESCRIPTION OF THE DRAWINGS

Exemplary embodiments of the present invention will be described in detail based on the following figures, wherein:

FIG. 1 is a front view illustrating part of a vehicle seat according to an exemplary embodiment;

FIG. 2 is a front view illustrating a frame of a seatback and a lock device of a vehicle seat according to an exemplary embodiment;

FIG. 3 is a front view illustrating an enlargement of part of the configuration illustrated in FIG. 2;

FIG. 4 is a first perspective view illustrating an enlargement of part of the configuration illustrated in FIG. 2;

FIG. 5 is a second perspective view illustrating an enlargement of part of the configuration illustrated in FIG. 2;

FIG. 6 is a side view illustrating an enlargement of part of the configuration illustrated in FIG. 2;

FIG. 7 is a perspective view illustrating an enlargement of part of the configuration illustrated in FIG. 4;

FIG. 8 is a first perspective view illustrating an enlargement of part of the configuration illustrated in FIG. 5;

FIG. 9 is a second perspective view illustrating an enlargement of part of the configuration illustrated in FIG. 5; and

FIG. 10 is a front view illustrating a lock main body, a lever bracket, and a strap of a lock device.

### DETAILED DESCRIPTION

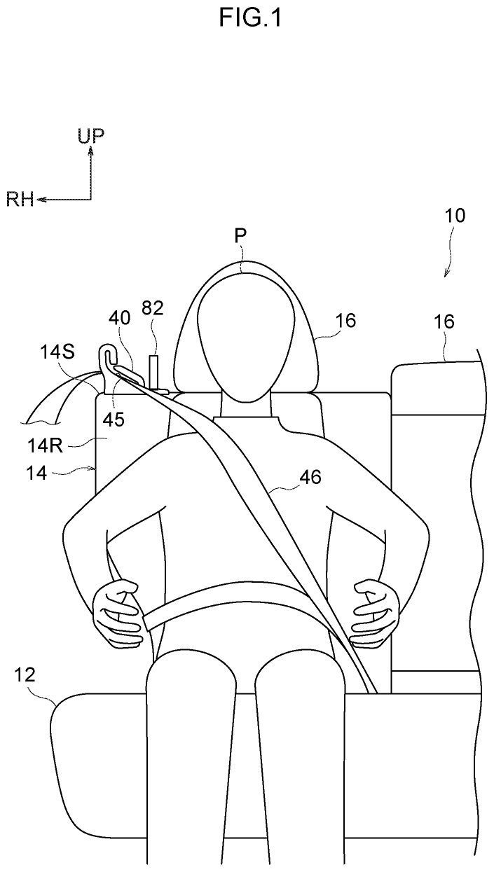

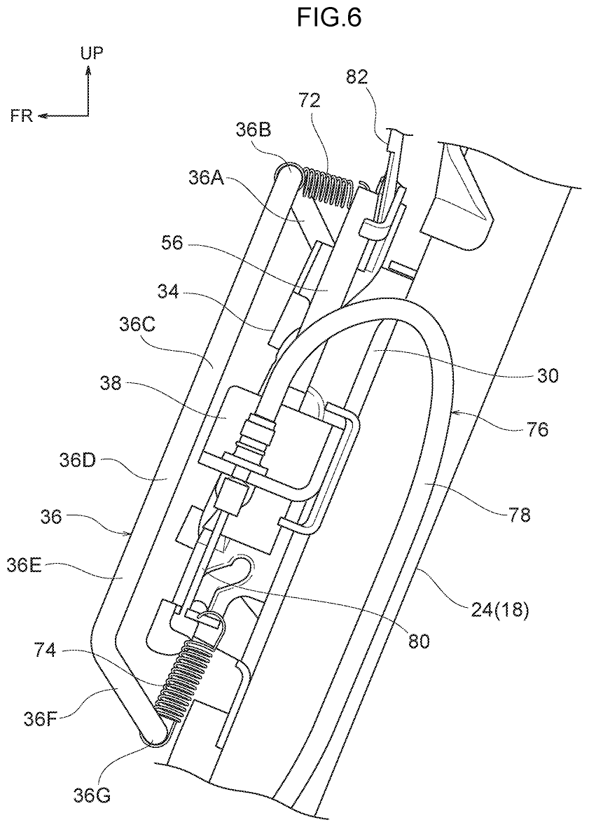

Description follows regarding a vehicle seat 10 according to an exemplary embodiment of the present disclosure, with reference to FIG. 1 to FIG. 9. Note that sometimes in the drawings reference numerals of parts are omitted in order increase readability of the drawings. Moreover, as appropriate in the drawings, the arrows FR, LH, RH, and UP respectively indicate forward, leftward, rightward, and upward directions of the vehicle seat 10. Hereinafter, when reference is simply given to front and rear, left and right, up and down in the following description then this indicates directions with respect to the vehicle seat 10.

As illustrated in FIG. 1, the vehicle seat 10 according to the present exemplary embodiment includes a seat cushion 12 for an occupant to sit on, a seatback 14 to support the back of the occupant, and a headrest 16 to support the head of the occupant. The vehicle seat 10 is, as an example, a three-person rear seat provided with respective headrests 16 at the left-right direction center and both left-right direction sides of an upper end section of the seatback 14 (the left headrest 16 is omitted in the drawings). The front and rear, left and right, and up and down directions of the vehicle seat 10 are aligned with the front and rear, left and right, and up and down directions of the vehicle.

The seatback 14 is divided into a right-side seatback 14R for two people, and a non-illustrated left-side seatback for one person. The right-side seatback 14R and the left-side seatback are each coupled so as to be swingable with respect to a floor section of a vehicle body through a non-illustrated hinge bracket and are configured so as to be tiltable in a forward direction over the seat cushion 12.

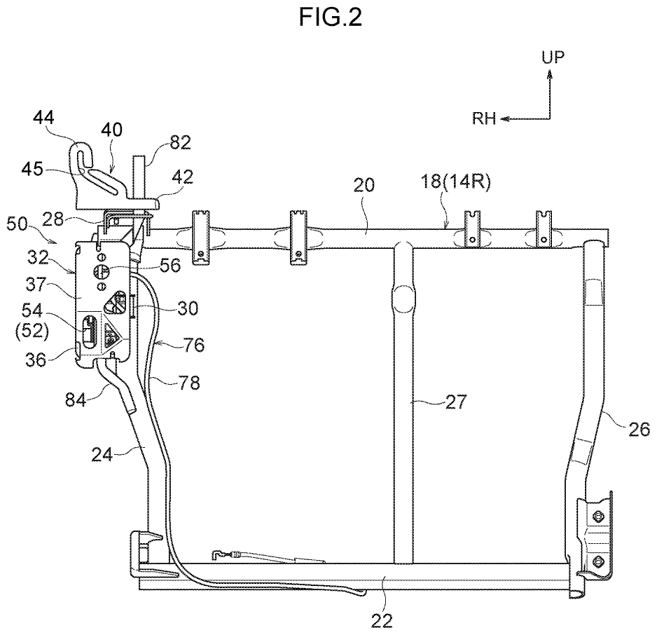

The right-side seatback 14R and the left-side seatback are each provided with a lock device 50 (see FIG. 2 to FIG. 9) to restrain the right-side seatback 14R and the left-side seatback in an upright position (the position illustrated in FIG. 1, hereafter referred to as “upright position”) to respective side portions of a non-illustrated vehicle body. Each of the lock devices 50 corresponds to a “seatback lock device” of the present disclosure.

Note that configuration in the vicinity of the lock devices 50 in the right-side seatback 14R and the left-side seatback is basically configured the same, other than being configured left-right symmetrical to each other, and so the configuration of the right-side seatback 14R will be described, with description of the configuration of the left-side seatback omitted. Moreover, reference below to front and rear, left and right, up and down directions indicate directions when the seatback 14R is positioned in the upright position.

The seatback 14R includes a frame 18 that is a framework member (see FIG. 2), a pad (reference numeral omitted) that is a cushion member, and a trim cover (reference numeral omitted) that is a covering. The frame 18 is, for example, configured as a frame shape by joining together metal pipe material and press-formed metal plate blanks. The pad is, for example, configured from a foam body of urethane foam or the like, and is coupled to the frame 18. The trim cover is, for example, formed in a bag shape by stitching together plural covering pieces of cloth material, leather, synthetic leather, or the like, and is covered over the seatback pad from the upper side thereof.

The frame 18 includes an upper frame section 20 that extends in the left-right direction at an upper end portion of the seatback 14R, a lower frame section 22 that extends in the left-right direction at a lower end portion of the seatback 14R, a right side frame section 24 that extends in the height direction at a right end portion of the seatback 14R, a left side frame section 26 that extends in the height direction at a left end portion of the seatback 14R, and an intermediate frame section 27 that extends in the height direction at a left-right direction intermediate portion of the seatback 14R.

As illustrated in FIG. 2, an upper bracket 28 configured from a press-formed metal plate blank is fixed to a right end portion of the upper frame section 20 of the frame 18. As illustrated in FIG. 2 to FIG. 8, a lock bracket 30 configured from a press-formed metal plate blank is fixed to an upper portion of the right side frame section 24. The upper bracket 28 and the lock bracket 30 configure part of the frame 18.

A seatbelt guide 40 is fixed to an upper face of the upper bracket 28. The seatbelt guide 40 is, as illustrated in FIG. 1, provided at a shoulder 14S on the right side of the seatback 14R. The seatbelt guide 40 includes a base 42 fixed to the upper bracket 28 by a means such as bolt fastening or the like, and a belt guide portion 44 that extends upward from the base 42. A slit 45 for insertion of a three-point seatbelt 46 is formed in the belt guide portion 44.

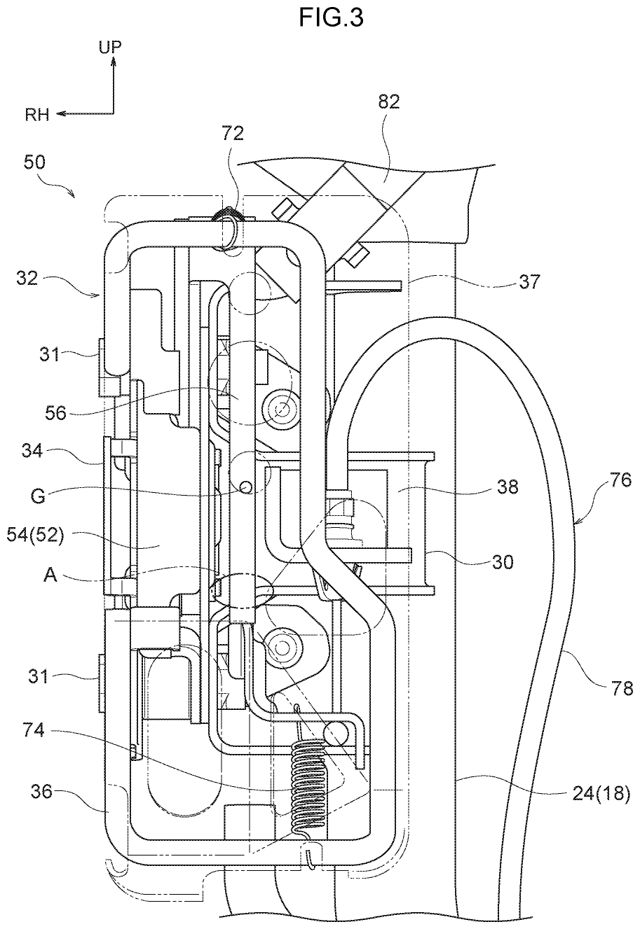

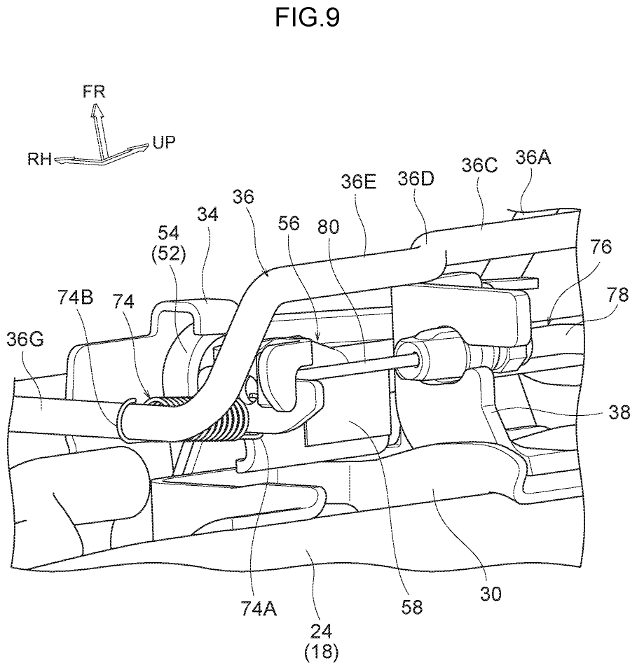

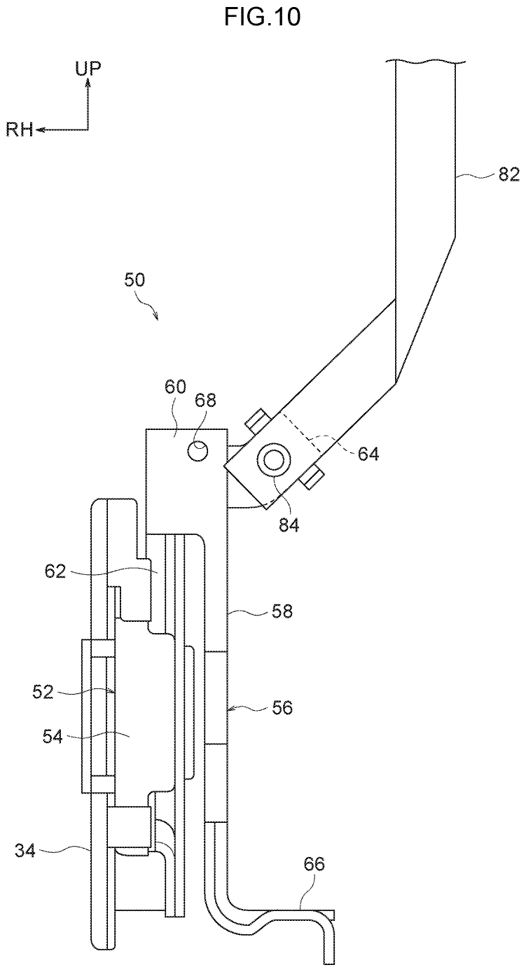

A lock main body 52 of the lock device 50, and a protection frame 32, serving as a protection member, are fixed to the lock bracket 30. As well as the lock main body 52 and the protection frame 32, the lock device 50 also includes a lever bracket 56 (see FIG. 3 to FIG. 10), and a strap 82 (see FIG. 1 to FIG. 6 and FIG. 10). The protection frame 32 includes an attachment bracket 34 (see FIG. 3 to FIG. 6, and FIG. 9 and FIG. 10), a wire member 36 (see FIG. 3 to FIG. 9), and a plate member 37 (see FIG. 2 to FIG. 3). The protection frame 32 corresponds to a “lever protector” of the present disclosure, and configures part of the frame 18

As illustrated in FIG. 3 to FIG. 5, the lock main body 52 of the lock device 50 includes a housing 54 fixed to the lock bracket 30. The housing 54 is configured by coupling plural press-formed metal plate blanks together, and is formed in a substantially box shape that has a length direction along the height direction is and flattened in the left-right direction. The housing 54 is fixed to the lock bracket 30 by fastening using bolts 31.

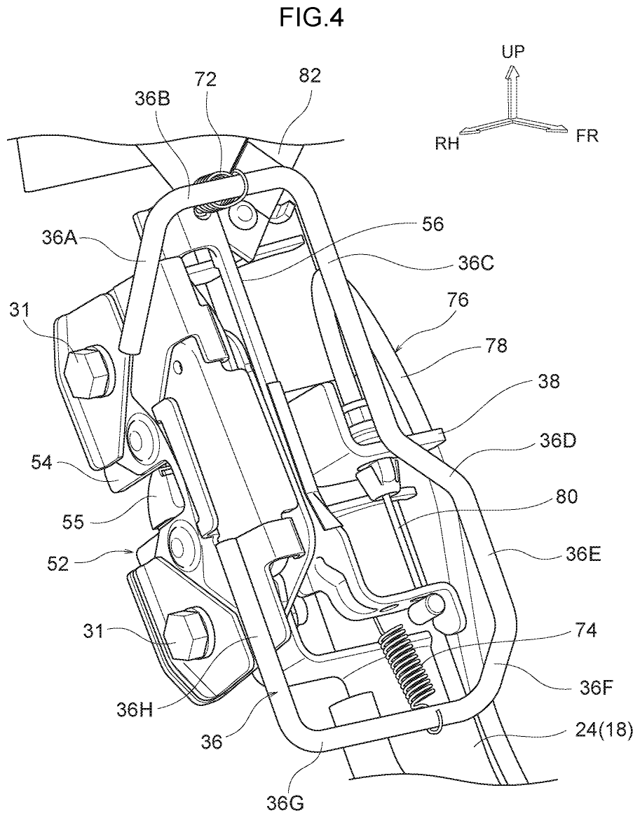

Mechanism components, such as a latch 55 (see FIG. 4) for engaging with a non-illustrated striker provided at the side portion of the vehicle body, are housed inside the housing 54. Due to such engagement, the seatback 14R is restricted from swinging with respect to the vehicle body and is restrained in the upright position. The latch 55 is attached so as to be rotatable with respect to the housing 54. Configuration is such that the engagement between the striker and the latch 55 is released by the latch 55 being rotated to the seat upper side. Swing restriction of the seatback 14R is release by such engagement release, enabling the seatback 14R to tilt forward onto the seat cushion 12.

The latch 55 is indirectly coupled to the lever bracket 56 (see FIG. 3 to FIG. 8), serving as a lever. The lever bracket 56 is, for example, configured from a press-formed metal plate blank and is arranged at the left side (seat width direction inner side) with respect to the lock main body 52. The lever bracket 56 is configured from a lever main body 58 that extends in the height direction at a vicinity of the left side of the lock main body 52, an outside projection 60 that projects from a front edge of an upper end portion of the lever main body 58 toward the right side (seat width direction outer side) and that is bend toward the rear side, a lock coupling portion 62 that extends downward from a leading end portion of the outside projection 60, a strap coupling portion 64 that extends diagonally toward the left side and the upper side from a rear edge portion of an upper end portion of the lever main body 58, and a cable coupling portion 66 extended toward the left side from a lower end portion of the lever main body 58.

A lower end portion of the lock coupling portion 62 of the lever bracket 56 is indirectly engaged with the latch 55 of the lock main body 52. Configuration is such that the latch 55 of the lock main body 52 rotates upward when the lever bracket 56 is displaced upward, so as to release engagement between the latch 55 of the lock main body 52 and the vehicle body side striker.

A one-end portion of an inner wire 80 of a remote cable 76 is coupled to a leading end portion of the cable coupling portion 66 of the lever bracket 56. A one-end portion of the outer casing 78 of the remote cable 76 is arranged above the cable coupling portion 66 and is fixed to a cable fixing bracket 38. The cable fixing bracket 38 is, for example, configured from press-formed metal plate blank, and is fixed to the lock bracket 30 by a means such as welding or the like. The remote cable 76 is, as illustrated in FIG. 2, routed through below the frame 18 to the rear side of the seatback 14R. Configuration is such that the lever bracket 56 is displaced upward when an other-end portion of the inner wire 80 of the remote cable 76 is pull-operated.

A one-end portion of the strap 82 is coupled to the strap coupling portion 64 of the lever bracket 56. The strap 82 is, for example, configured from an elongated strip shaped material made from synthetic fibers or the like, and exhibits flexibility. The other-end side of the strap 82 is inserted through a non-illustrated strap pull-out opening formed in the base 42 of the seatbelt guide 40, and is pulled toward the upper side of the seatback 14R. Configuration is such that the lever bracket 56 is displaced upward when the other-end side of the strap 82 is pull-operated upward by an occupant.

As described above, the latch 55 of the lock main body 52 is rotated upward with respect to the housing 54 when the lever bracket 56 is displaced upward, in a configuration such that the engagement between the latch 55 of the lock main body 52 and the vehicle body side striker is released.

The protection frame 32 includes, as stated previously, the attachment bracket 34, the wire member 36, and the plate member 37. As illustrated in FIG. 3 to FIG. 6, the attachment bracket 34 is, for example, configured from a press-formed metal plate blank and is arranged at a right side of the lock main body 52 orientated with its thickness direction along the left-right direction. The attachment bracket 34 is fixed to the lock bracket 30 by fastening using bolts 31.

As illustrated in FIG. 3 to FIG. 8, the wire member 36 is, for example, configured by bend-processed metal wire material formed in a substantially rectangular frame shape having a length along the height direction as viewed along the front-rear direction. The wire member 36 is fixed to the right side frame section 24, which is a right side portion of the frame 18 of the seatback 14R, through the attachment bracket 34, the lock main body 52, and the lock bracket 30.

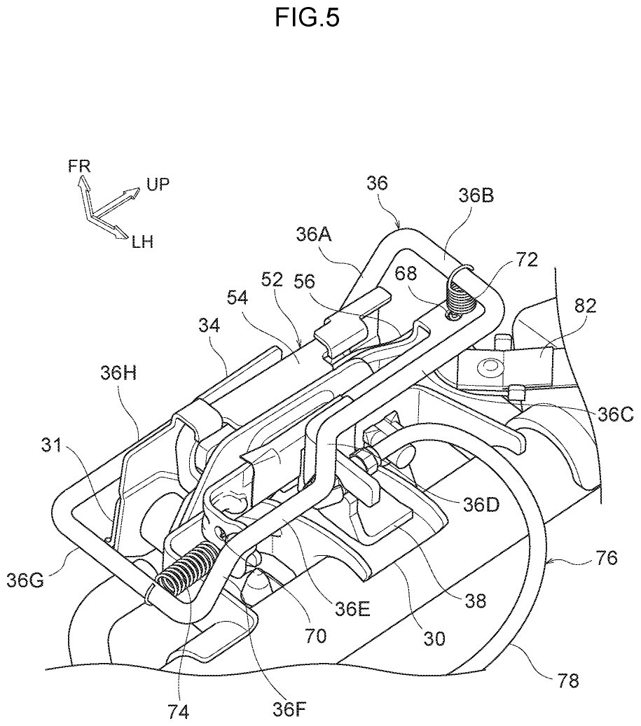

As illustrated in FIG. 4 and FIG. 5, the wire member 36 is configured from a first fixing portion 36A extending diagonally forward and upward from an upper portion of the attachment bracket 34, the first lateral extension portion 36B extending toward the left side from an upper end portion of the first fixing portion 36A, a first vertical extension portion 36C extending diagonally downward and forward from a left end portion of the first lateral extension portion 36B, an inclined portion 36D extending diagonally toward the left side and downward from a lower end portion of the first vertical extension portion 36C, a second vertical extension portion 36E extending diagonally downward and forward from a lower end portion of the inclined portion 36D, a rear extension portion 36F extending diagonally rearward and downward from a lower end portion of the second vertical extension portion 36E, the second lateral extension portion 36G extending toward the right side from a rear end portion of the rear extension portion 36F, and a second fixed portion 36H extending diagonally upward and rearward from a right end portion of the second lateral extension portion 36G.

The first fixing portion 36A is superimposed on an upper portion of the attachment bracket 34 from the right side, and is fixed to the upper portion of the attachment bracket 34 by a means such as welding or the like. The second fixed portion 36H is superimposed on a lower portion of the attachment bracket 34 from the right side, and is fixed to the lower portion of the attachment bracket 34 by a means such as welding or the like. The first lateral extension portion 36B is arranged separated from the lock main body 52 and the lever bracket 56 at the front side and upper side thereof. The first vertical extension portion 36C, the inclined portion 36D, the second vertical extension portion 36E, and the rear extension portion 36F are arranged separated to the front side and the left side with respect to the lock main body 52 and the lever bracket 56. The second lateral extension portion 36G is arranged separated from the lock main body 52 and the lever bracket 56 at the front side and lower side thereof.

As illustrated in FIG. 2 and FIG. 3, the plate member 37 is, for example, configured from a press-formed metal plate blank, and is formed in a substantially rectangular plate shape having a length along the height direction as viewed along the front-rear direction. The first lateral extension portion 36B, the first vertical extension portion 36C, the inclined portion 36D, the second vertical extension portion 36E, the rear extension portion 36F, and the second lateral extension portion 36G of the wire member 36 are in contact with the rear face of the plate member 37. The wire member 36 is fixed to the plate member 37 by a means such as welding or the like. Plural through holes (reference numeral omitted) are formed in the plate member 37. An outside edge of the plate member 37 is bend and folded toward the rear side. The front face of the plate member 37 contacts the pad of the seatback 14R.

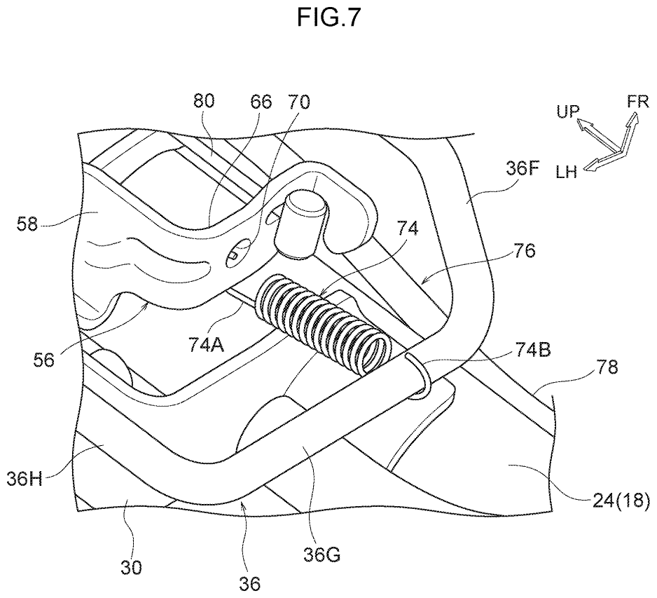

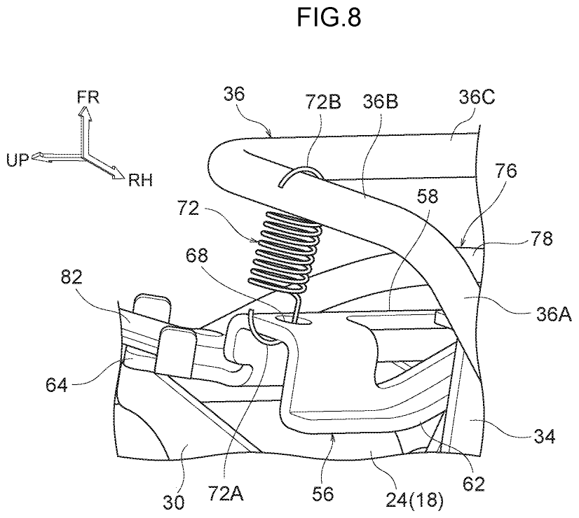

The protection frame 32 configured as described above covers the lock main body 52, the lever bracket 56, the one-end portion of the outer casing 78, and the one-end portion of the inner wire 80, from the front side. Circular shaped through holes 68, 70 are respectively formed in the outside projection 60 and the cable coupling portion 66 of the lever bracket 56 (see FIG. 4, FIG. 5, FIG. 7, and FIG. 8). These through holes 68, 70 respectively correspond to tension coil springs 72, 74. The tension coil spring 72 corresponds to a “forward urging member” of the present disclosure, and the tension coil spring 74 corresponds to a “downward urging member” of the present disclosure. The tension coil spring 72 is arranged further to the upper side than the tension coil spring 74.

The one-end portions 72A, 74A and other-end portions 72B, 74B of the tension coil springs 72, 74 are each bend-processed into a semicircular arc shape. The one-end portion 72A of the tension coil spring 72 is inserted through the through hole 68 and anchored (hooked) onto the outside projection 60. The other-end portion 72B of the tension coil spring 72 is anchored onto an upper end portion (the first lateral extension portion 36B) of the wire member 36. The tension coil spring 72 is thereby spanned between an upper end portion of the lever bracket 56 and a lower end portion of the protection frame 32.

The tension coil spring 72 is arranged with its axial direction substantially along the front-rear direction, and urges the upper end portion of the lever bracket 56 forward. The one-end portion 72A of the tension coil spring 72 curves in a direction to be inserted even deeper into the through hole 68 of the outside projection 60 when the lever bracket 56 is displaced upward. From the perspective of ease of assembly to the first lateral extension portion 36B of the wire member 36, the other-end portion 72B of the tension coil spring 72 is hooked onto the first lateral extension portion 36B from the lower side and front side thereof.

Moreover, due to the upper end portion of the lever bracket 56 being urged forward as described above, the lower portion of the lever main body 58 of the lever bracket 56 is press against the lock bracket 30 (namely, against part of the frame 18) (see the region indicated by double-dot broken lines A in FIG. 3, and FIG. 9). A location where the lever main body 58 is pressed toward the lock bracket 30 is, as illustrated in FIG. 3, set further to the lower side than the center of gravity G of the lever bracket 56.

The one-end portion 74A of the tension coil spring 74 is inserted through the through hole 70 and anchored onto the cable coupling portion 66. The other-end portion 74B of the tension coil spring 74 is anchored to the lower end portion of the wire member 36 (the second lateral extension portion 36G). The tension coil spring 74 is thereby spanned between a lower end portion of the lever bracket 56 and a lower end portion of the protection frame 32.

The tension coil spring 74 is arranged with its axial direction substantially along the height direction, and urges the lever bracket 56 downwards. The urging direction of the lever bracket 56 due to the tension coil spring 74 is set to a direction that maintains the locking of the lock main body 52. The ease of locking of the lock main body 52 is raised thereby. The tension coil spring 74 is arranged substantially directly below the center of gravity G of the lever bracket 56 so as to enable urging force (spring force) to be caused to act efficiently against inertia of the lever bracket 56 moving upward during vehicle travel and the like.

From the perspective of ease of assembly to the cable coupling portion 66, the one-end portion 74A of the tension coil spring 74 is hooked onto the through hole 70 from the rear side and the upper side. Similarly, from the perspective of ease of assembly to the second lateral extension portion 36G of the wire member 36, the other-end portion 74B of the tension coil spring 74 is hooked onto the second lateral extension portion 36G from the rear side and the lower side.

In the vehicle seat 10 of the above configuration, the back of an occupant seated on the seat cushion 12 is supported by the seatback 14R. The seatback 14R is coupled so as to be swingable with respect to the vehicle body. The lock main body 52 of the lock device 50 is provided at a side section of the seatback 14R. Swinging of the seatback 14R is restricted by the latch 55 provided at the lock main body 52 being engaged with the striker provided at the side portion of the vehicle body. The lever bracket 56 arranged at the left side with respect to the lock main body 52 is indirectly engaged with the latch 55.

The strap 82 and the inner wire 80 of the remote cable 76 are coupled to the lever bracket 56. The strap 82 displaces the lever bracket 56 upward by being pulled. The remote cable 76 displaces the lever bracket 56 upward by the inner wire 80 being pulled by remote operation while the one-end portion of the outer casing 78 is being supported by the side portion of the frame. In this manner, the lever bracket 56 is displaced upward, and the engagement between the latch 55 and the striker is released. This thereby enables the seatback 14R to be tilted forward onto the seat cushion 12.

The tension coil spring 74 is spanned between the lever bracket 56 and the frame 18 of the seatback 14R. The lever bracket 56 is urged downward by the tension coil spring 74. Unwanted release of the locking of the lock main body 52 can be prevented due to being able to prevent the lever bracket 56 from being lifted up unintentionally by inertial force during a vehicle collision or the like.

Moreover, in the present exemplary embodiment, an upper end portion of the lever bracket 56 is urged forward by the tension coil spring 72 spanned between the lever bracket 56 and the frame 18 of the seatback 14R. This thereby enables the lever bracket 56 to be prevented from interfering with other component due to, for example, vibration during vehicle travel, vibration when an occupant has hit the seatback 14R, and the like, enabling abnormal noises from such interference to be prevented from being generated.

Moreover, in the present exemplary embodiment, part of the lever bracket 56 is being pressed against the lock bracket 30, which is part of the frame 18, by the urging force of the tension coil spring 72, enabling the generation of abnormal noise from such interference to be even better prevented. Moreover, due to adopting such a configuration in which the upper end portion of the lever bracket 56 is urged forward by the tension coil spring 72, and the lower portion of the lever main body 58 is pressed against the lock bracket 30, the urging force of the tension coil spring 72 can be set small.

Moreover, in the present exemplary embodiment, the tension coil spring 72 that urges the lever bracket 56 forward is arranged further upward than the tension coil spring 74 that urges the lever bracket 56 downward. A configuration is accordingly achieved in which downward urging of the lever bracket 56 by the tension coil spring 74 is not impeded by the tension coil spring 72.

Moreover, in the present exemplary embodiment, the lever bracket 56 is covered from the front side by the protection frame 32 provided at the frame 18. The tension coil spring 74 is spanned between a lower end portion of the protection frame 32 and the lever bracket 56, thereby enabling the lever bracket 56 to be urged downward by the tension coil spring 74 efficiently.

Furthermore, in the present exemplary embodiment, the tension coil spring 72 is spanned between the upper end portion of the protection frame 32 and the lever bracket 56, enabling the lever bracket 56 to be efficiently urged forward by the tension coil spring 72.

Moreover, in the present exemplary embodiment, the lever bracket 56 is always being pulled by the tension coil springs 72, 74, and so generation of abnormal noise due to unwanted movement due to vibration or the like of the lever bracket 56 can be prevented. Moreover, the lever bracket 56 can be prevented from moving in an un-planned direction when, for example, the frame 18 is being transported with the lock device 50 and the like attached thereto, enabling deformation or scratching of the lever bracket 56 and the like to be prevented due to being able to stabilize packing.

Note that although in the configuration of the above exemplary embodiment the frame 18 of the seatback 14R includes the protection frame 32, there is no limitation thereto, and a configuration lacking the protection frame 32 may be adopted. In such cases, the tension coil springs 72, 74 are configured coupled to the frame 18 through a separate bracket or the like.

Moreover, although in the configuration of the above exemplary embodiment it is the tension coil spring 72 that serves as a forward urging member and it is the tension coil spring 74 that serves as a downward urging member, there is no limitation thereto, and the forward urging member and the downward urging member may be configured from members other than tension coil springs.

Moreover, although in the above exemplary embodiment a case has been described in which the vehicle seat 10 is configured with a right-side section and a left-right direction central section of a three-person rear seat, there is no limitation thereto. In cases in which the vehicle seat 10 according to the present disclosure is configured by a left-side section and a left-right direction central section of a three-person rear seat, the configuration is left-right symmetrical to the exemplary embodiment described above. Moreover, the seatback of the vehicle seat according to the present disclosure is not limited to being a dividable seat.

Moreover, although in the above exemplary embodiment a case has been described in which the present disclosure is applied to the vehicle seat 10, there is no limitation thereto, and the present disclosure is applicable to a transportation seat other than in a vehicle (such as in an aircraft or a ship).

In addition thereto, various other modifications may be implemented for the present disclosure within a range not departing from the spirit thereof. Moreover, obviously the scope of rights of the present disclosure is not limited to the above exemplary embodiment.

What is claimed is:

1. A seatback lock device comprising:
a lock main body that is coupled to a side portion of a frame of a seatback, so as to be tiltable in a forward direction with respect to a floor section of a vehicle body, and that engages with a striker provided at a side portion of the vehicle body;
a lever that is arranged at a seat width direction inner side with respect to the lock main body so as to be coupled to the lock main body, and that releases engagement between the lock main body and the striker by being displaced toward a seat upper side; and
a downward urging member that is spanned between the lever and the frame, and that urges the lever toward a seat lower side.

2. The seatback lock device of claim 1, further comprising a forward urging member that spans between the lever and the frame, and that urges the lever toward a seat front side.

3. The seatback lock device of claim 2, wherein part of the lever is pressed against part of the frame by urging force of the forward urging member.

4. The seatback lock device of claim 2, wherein the forward urging member is arranged further toward the seat upper side than the downward urging member.

5. The seatback lock device of claim 1, wherein:
the frame includes a lever protector covering the lever from a seat front side; and
the downward urging member spans between a lower end portion of the lever protector and the lever.

6. The seatback lock device of claim 5, further comprising a forward urging member that spans between the lever and the frame, and that urges the lever toward a seat front side, and the forward urging member spans between an upper end portion of the lever protector and the lever.

7. A vehicle seat comprising:
a seat cushion for an occupant of a vehicle to sit on;
a seatback that is coupled so as to be swingable with respect to a vehicle body and that supports a back of the occupant; and
the seatback lock device of claim 1, wherein the lock main body is provided at a side portion of the seatback.
